(19) United States
(12) Patent Application Publication
(10) Pub. No.: US 2015/0237240 A1
(43) Pub. Date: Aug. 20, 2015

(54) SUSPENSION FOR CAMERA MODULE AND CAMERA MODULE HAVING THE SAME

(71) Applicant: SAMSUNG ELECTRO-MECHANICS CO., LTD., Suwon-Si (KR)

(72) Inventor: Young-Kyu PARK, Suwon-Si (KR)

(21) Appl. No.: 14/489,044

(22) Filed: Sep. 17, 2014

(30) Foreign Application Priority Data
Feb. 17, 2014 (KR) 10-2014-0018057

(51) Int. Cl. H04N 5/225

(52) U.S. Cl. CPC H04N 5/2254

(57) ABSTRACT

A suspension for a camera module and a camera module having the suspension are disclosed. A suspension for a camera module is installed between an optical unit and housing having the optical unit received therein in such a way that the suspension is extended in a direction of optical axis, and the suspension supports the optical unit in such a way that the optical unit is floated from a bottom face of the housing. The suspension includes: a first wire having one end thereof coupled with the optical unit; a second wire having one end thereof coupled with the housing; and a plate member interposed between the first wire and the second wire and comprising a plurality of openings.

### CROSS-REFERENCE TO RELATED APPLICATIONS

This application claims the benefit of Korean Patent Application No. 10-2014-0018057, filed with the Korean Intellectual Property Office on Feb. 17, 2014, the disclosure of which is incorporated herein by reference in its entirety.

### BACKGROUND

1. Technical Field

The present invention relates to a suspension for a camera module and a camera module having the suspension.

2. Background Art

A camera needs a certain amount of light in order to have a high quality of image. However, at a time of low illumination, the shutter of the camera needs to remain open for an extended period of time in order to receive a sufficient amount of light, and if the camera is shaken from outside at this time, the photographed image becomes blurred. Introduced to prevent this shortcoming is optical image stabilization (OIS).

OIS compensates for handshaking, by allowing an optical unit to be floated by a suspension and to be moved in an opposite direction to a direction in which the shaking has occurred.

However, in the case where the OIS function is not working, and if the suspension for supporting the optical unit is not elastic enough, the lens may sag toward a particular direction, and as a result, the photographed image appear quite unnatural.

The related art of the present invention is disclosed in Korea Patent Publication No. 10-2012-0099945 (SUSPENSION WIRE FOR COMPENSATION HAND VIBRATION AND IMAGE PHOTOGRAPHING DEVICE HAVING THE SAME; laid open on Sep. 12, 2012).

### SUMMARY

The present invention provides a suspension that can prevent sagging of an optical unit and a camera module having such suspension.

An aspect of the present invention features a camera module that includes: an optical unit; housing having the optical unit received therein; and a suspension installed between the optical unit and the housing in such a way that the suspension is extended in a direction of optical axis, and supporting the optical unit in such a way that the optical unit is floated from a bottom face of the housing. The suspension includes a plate member having a plurality of openings formed therein.

The suspension can include: a first wire formed at an upper portion of the plate member in such a way that one end thereof is coupled with the optical unit; and a second wire formed at a lower portion of the plate member in such a way that one end thereof is coupled with the housing.

The first wire and the second wire can be each extended in the direction of optical axis.

The first wire and the second wire can be formed on a same line corresponding to a middle line of the plate member.

A portion of the first wire can be bent in such a way that an outer circumferential surface thereof is coupled to the optical unit.

The plate member can be formed in a mesh structure by the plurality of openings.

The optical unit can include: a bobbin; a lens unit installed in the bobbin; and a driving unit configured to drive the lens unit in the direction of optical axis.

The camera module can further include a printed circuit board having an image sensor mounted thereon at a position corresponding to the lens unit, and the printed circuit board can be coupled at a lower side of the housing.

Another aspect of the present invention features a suspension for a camera module that is installed between an optical unit and housing having the optical unit received therein in such a way that the suspension is extended in a direction of optical axis and that supports the optical unit in such a way that the optical unit is floated from a bottom face of the housing. The suspension for a camera module in accordance with an embodiment of the present invention include: a first wire having one end thereof coupled with the optical unit; a second wire having one end thereof coupled with the housing; and a plate member interposed between the first wire and the second wire and comprising a plurality of openings.

The first wire and the second wire can be extended in the direction of optical axis.

The first wire and the second wire can be formed on a same line corresponding to a middle line of the plate member.

A portion of the first wire can be bent in such a way that an outer circumferential surface thereof is coupled to the optical unit.

The plate member can be formed in a mesh structure by the plurality of openings.

### BRIEF DESCRIPTION OF THE DRAWINGS

FIG. 1 is an exploded perspective view showing a camera module in accordance with an embodiment of the present invention.

FIG. 2 is a cross-sectional view showing the camera module in accordance with an embodiment of the present invention.

FIG. 3 shows a suspension in accordance with an embodiment of the present invention.

### DETAILED DESCRIPTION

Hereinafter, certain embodiments of a suspension for a camera module and a camera module having the suspension in accordance with the present invention will be described in detail with reference to the accompanying drawings. In describing the present invention with reference to the accompanying drawings, any identical or corresponding elements will be assigned with same reference numerals, and no redundant description thereof will be provided.

Terms such as “first” and “second” can be used in merely distinguishing one element from other identical or corresponding elements, but the above elements shall not be restricted to the above terms.

When one element is described to be “coupled” to another element, it does not refer to a physical, direct contact between these elements only, but it shall also include the possibility of yet another element being interposed between these elements and each of these elements being in contact with said yet another element.

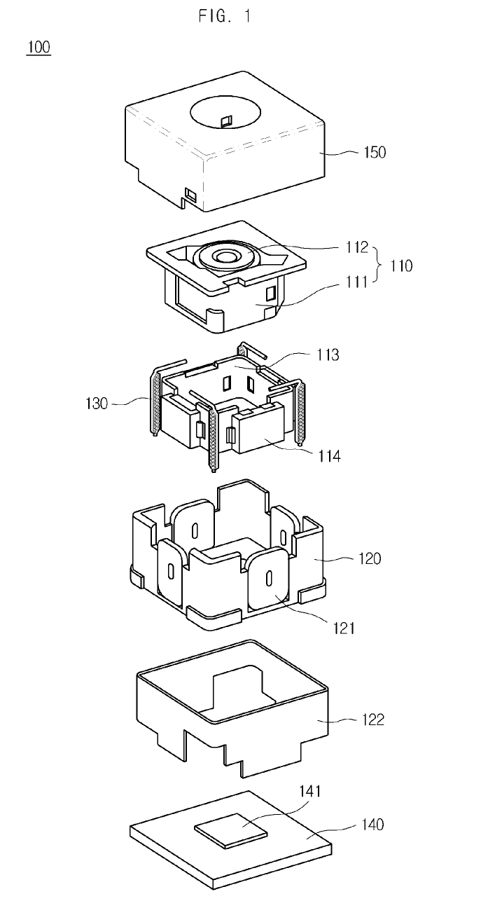

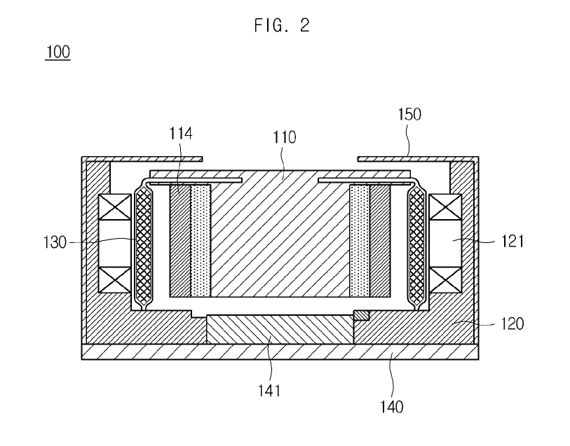

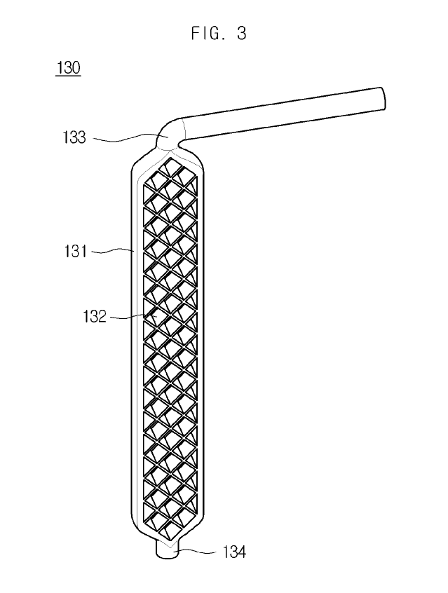

FIG. 1 is an exploded perspective view showing a camera module in accordance with an embodiment of the present invention, and FIG. 2 is a cross-sectional view showing the camera module in accordance with an embodiment of the present invention. FIG. 3 shows a suspension in accordance with an embodiment of the present invention.

Referring to FIG. 1 and FIG. 2, a camera module 100 in accordance with an embodiment of the present invention can include an optical unit 110, housing 120 and a suspension 130, and can further include a printed circuit board 140. Moreover, referring to FIG. 3, the suspension 130 can include a first wire 133, a second wire 134 and a plate member 131.

The optical unit 110 is a portion that receives light. The optical unit 110 can include a bobbin 111, a lens unit 112 and a driving unit.

The lens unit 112 can include a plurality of lenses and a lens barrel. The lens unit 112 can be installed within the bobbin 111. The driving unit can drive the lens unit 112 in an optical-axis direction. Accordingly, an autofocusing function of the camera module 100 can be implemented.

The driving unit can drive the lens unit 112 by use of a VCM (voice coil motor) method, which drives the lens unit 112 up and down using electromagnetic force, an ultrasonic motor method, which uses a piezoelectric device, etc.

The housing 120 is a case that has the optical unit 110 received therein. The housing 120 can have a top face and a bottom face that are open. The optical unit 110 can be received through the open top face. An image sensor 141 of the printed circuit board 140 can be received in the bottom face.

The housing 120 can have a coil 121 installed on each of four faces thereof. The coil 121 can move the optical unit 110 horizontally, together with a magnet 114, which is installed on a yoke 113 on an outside of the optical unit 110. That is, by installing the coil 121 and the magnet 114 at opposite positions to each other, the optical unit 110 can be moved by an interaction between an electric field, which is created by electric current supplied to the coil 121, and a magnetic field, which is created by the magnet 114. Here, the electric current supplied to the coil 121 can be supplied through a flexible printed circuit board 122 that envelops outside surfaces of the housing 120.

The suspension 130 elastically supports the optical unit 110 within the housing 120. The suspension 130 has an upper portion thereof coupled to the optical unit 110 and a lower portion thereof coupled to the housing 120, and can be installed in between the optical unit 110 and the housing 120 and to be extended along an optical axis.

The suspension 130 supports the optical unit 110 elastically within the housing 120 and, at the same time, allows the optical unit 110 to readily move in a direction for compensating for handshaking in case horizontal handshaking occurs with the camera module 100. That is, the suspension 130 supports the optical unit 100 in such a way that the optical unit 110 is floated from a bottom face of the housing 120.

The lower portion of the suspension 130 can be electrically connected with the printed circuit board 140, and the upper portion of the suspension 130 can be coupled with the optical unit 110 to supply electric power to the driving unit of the optical unit 110. In such a case, the suspension 130 can be made of a conductive material, for example, metal.

The suspension 130 can include the plate member 131 that includes a plurality of openings 132. The suspension 130 in the form of plate member 131 has greater elasticity and restitution than the conventional wire type of suspension. Moreover, by forming the plurality of openings 132, freer movement of the suspension 130 can be provide than when there are no openings formed in the plate-type suspension.

The opening 132 can be formed in various shapes, such as a circle, a rhombus, a rectangle, etc. The plate member 131 can be formed in a mesh structure by the plurality of openings 132. The shape, size and number of the openings 132 can be variably modified by a user according to a weight of the optical unit 110.

The suspension 130 can include the first wire 133 and the second wire 134. The first wire 133 can be formed at an upper portion of the plate member 131 so as to be connected with the optical unit 110, and the second wire 134 can be formed at a lower portion of the plate member 131 so as to be coupled with the housing 120.

The first wire 133 and the second wire 134 can facilitate coupling of the suspension 130, the optical unit 110 and the housing 120 with one another. The upper portion and the lower portion of the plate member 131 can be wider than the wires 133, 134, and the plate member 131 can be coupled with the optical unit 110 and the housing 120 more readily by way of the wires 133, 134 than if the plate member 131 was coupled with the optical unit 110 and the housing 120 directly.

The first wire 133 and the second wire 1343 can have a cylindrical shape. Diameters of the first wire 133 and the second wire 134 can each be the same as a thickness of the plate member 131. The first wire 133 and the second wire 134 can be extended in a direction of optical axis.

The first wire 133 and the second wire 134 can be formed on a same line that corresponds to a middle line of the plate member 131. Accordingly, the shape of the suspension 130 can be symmetrical about the middle line of the plate member 131. In such a case, the suspension 130 can stably support the optical unit 110.

Lengths of the first wire 133 and the second wire 134 can be each shorter than a length of the plate member 131. That is, the first wire 133 and the second wire 134 can function to couple the suspension 130, the optical unit 110 and the housing 120 with one another, and the plate member 131 can function to support the optical unit 110.

Referring to FIG. 3, a portion of the first wire 133 can be bent. The bent portion of the first wire 133 can be inserted in the optical unit 110. In other words, an outer circumferential surface of the bent first wire 133 can be coupled to the optical unit 110. In such a case, an area of contact can be increased, thereby improving coherence.

The printed circuit board 140 has the image sensor 141 mounted thereon at a position corresponding to the lens unit 112, and is coupled at a lower side of the housing 120. The printed circuit board 140 can function to supply electric power to the image sensor 140 and the driving unit of the optical unit 110.

The camera module 100 can also include a shield can 150, which is for protecting internal parts of the camera module 100 from external electromagnetic waves. The shield can 150 can be made of a metallic material, and can be coupled to the printed circuit board 140 so as to cover the optical unit 110.

As described above, according to a suspension for a camera module and a camera module having the suspension in accordance with an embodiment of the present invention, the suspension supporting the optical unit can have a greater elasticity than the wire-type suspension and a freer movement than the plate-type suspension.

If the suspension is sufficiently elastic, the optical unit can be supported with or without the OIS function. Since the camera is typically used with the lens facing forward, it is important to support the optical unit without allowing the optical unit to sag.

Moreover, with the freely moving suspension, less electric current is required for driving the OIS function, making it possible to save costs.

Ultimately, not only can the clarity and quality of image be improved by the suspension in accordance with an embodiment of the present invention, but the electric current and costs for driving the camera module can be saved.

Although a certain embodiment of the present invention has been described hitherto, it shall be appreciated that the present invention can be variously modified and permutated by those of ordinary skill in the art to which the present invention pertains by supplementing, modifying, deleting and/or adding an element without departing from the technical ideas of the present invention, which shall be defined by the claims appended below. It shall be also appreciated that such modification and/or permutation are also included in the claimed scope of the present invention.

What is claimed is:

1. A camera module comprising:
an optical unit;
housing having the optical unit received therein; and
a suspension installed between the optical unit and the housing in such a way that the suspension is extended in a direction of optical axis, and supporting the optical unit in such a way that the optical unit is floated from a bottom face of the housing,
wherein the suspension comprises a plate member having a plurality of openings formed therein.

2. The camera module of claim 1, wherein the suspension comprises:
a first wire formed at an upper portion of the plate member in such a way that one end thereof is coupled with the optical unit; and
a second wire formed at a lower portion of the plate member in such a way that one end thereof is coupled with the housing.

3. The camera module of claim 2, wherein the first wire and the second wire are each extended in the direction of optical axis.

4. The camera module of claim 2, wherein the first wire and the second wire are formed on a same line corresponding to a middle line of the plate member.

5. The camera module of claim 2, wherein a portion of the first wire is bent in such a way that an outer circumferential surface thereof is coupled to the optical unit.

6. The camera module of claim 1, wherein the plate member is formed in a mesh structure by the plurality of openings.

7. The camera module of claim 1, wherein the optical unit comprises:
a bobbin;
a lens unit installed in the bobbin; and
a driving unit configured to drive the lens unit in the direction of optical axis.

8. The camera module of claim 1, further comprising a printed circuit board having an image sensor mounted thereon at a position corresponding to the lens unit, the printed circuit board being coupled at a lower side of the housing.

9. A suspension for a camera module installed between an optical unit and housing having the optical unit received therein in such a way that the suspension is extended in a direction of optical axis, and supporting the optical unit in such a way that the optical unit is floated from a bottom face of the housing, the suspension comprising:
a first wire having one end thereof coupled with the optical unit;
a second wire having one end thereof coupled with the housing; and
a plate member interposed between the first wire and the second wire and comprising a plurality of openings.

10. The suspension for a camera module of claim 9, wherein the first wire and the second wire are extended in the direction of optical axis.

11. The suspension for a camera module of claim 9, wherein the first wire and the second wire are formed on a same line corresponding to a middle line of the plate member.

12. The suspension for a camera module of claim 9, wherein a portion of the first wire is bent in such a way that an outer circumferential surface thereof is coupled to the optical unit.

13. The suspension for a camera module of claim 9, wherein the plate member is formed in a mesh structure by the plurality of openings.
